(19) United States
(12) Patent Application Publication
(10) Pub. No.: US 2011/0298896 A1
(43) Pub. Date: Dec. 8, 2011

(54) SPECKLE NOISE REDUCTION FOR A COHERENT ILLUMINATION IMAGING SYSTEM

(75) Inventors: Robert F. Dillon, Bedford, NH (US); Neil H. K. Judell, Newton, MA (US); Timothy I. Fillion, Bedford, MA (US); Ran Yi, Watertown, MA (US)

(73) Assignee: DIMENSIONAL PHOTONICS INTERNATIONAL, INC., Wilmington, MA (US)

(21) Appl. No.: 13/201,698

(22) PCT Filed: Feb. 19, 2010
(86) PCT No.: PCT/US2010/024694

§ 371 Date: Aug. 16, 2011

Related U.S. Application Data
(60) Provisional application No. 61/154,566, filed on Feb. 23, 2009.

(51) Int. Cl. G02B 27/48; G02B 27/10; G02B 26/10; H04N 13/02; G02B 26/08

(52) U.S. Cl. 348/46; 359/298; 359/212.1; 359/618; 359/619; 348/E13.074

(57) ABSTRACT

Described are methods and apparatus for reducing speckle noise in images, such as images of objects illuminated by coherent light sources and images of objects illuminated by interferometric fringe patterns. According to one method, an object is illuminated with a structured illumination pattern of coherent radiation projected along a projection axis. An angular orientation of the projection axis is modulated over an angular range during an image acquisition interval. Advantageously, shape features of the structured illumination pattern projected onto the surface of the object remain unchanged during image acquisition and the acquired images exhibit reduced speckle noise. The structured illumination pattern can be a fringe pattern such as an interferometric fringe pattern generated by a 3D metrology system used to determine surface information for the illuminated object.

### RELATED APPLICATIONS

This application claims the benefit of the earlier filing date of U.S. Provisional Patent Application Ser. No. 61/154,566, filed Feb. 23, 2009, titled “Method and Apparatus to Reduce Speckle in Coherent Light Imaging,” the entirety of which is incorporated herein by reference.

### FIELD OF THE INVENTION

The invention relates generally to intensity noise reduction in illumination systems and more particularly to intensity noise reduction in a coherent fringe imaging system.

### BACKGROUND OF THE INVENTION

Precision non-contact three-dimensional (“3D”) metrology based on fringe interferometry has been developed for industrial applications. Measurements are typically performed for large volumes at low data acquisition rates. These systems detect interference fringes generated by two coherent light sources and projected onto the surface of an object being measured. For a variety of applications, including medical applications and dental imaging, a 3D imaging system requires increased resolution; however, the use of coherent illumination to generate the fringe pattern at the object results in speckle noise in the acquired images of the fringe pattern. In general, the speckle noise becomes more significant as spatial resolution is improved.

Speckle occurs in coherent imaging optical systems at the imager and is a function of the surface roughness of the object, and the wavelength and coherence length of the coherent light source. Imaging geometry parameters such as aperture size, incident angle and viewing angle also affect speckle. Surface roughness within the object area imaged by a single detector element (i.e., pixel) results in varied optical path lengths for the light scattered from the area. Thus the light received at the pixel can interfere in a constructive or destructive manner so that the pixel intensity can vary from the pixel intensity that would otherwise result from incoherent illumination. A low resolution optical imaging systems images a large object surface area onto each pixel, thereby suppressing the effect of speckle by averaging many spatially-varying intensity features on the pixel. In contrast, a higher resolution optical system images a correspondingly smaller object surface area onto each pixel with fewer spatially-varying intensity features, resulting in an image with increased speckle noise.

Thus there is a need in fringe interferometry to reduce image degradation due to speckle noise to enable high resolution images that do not sacrifice measurement accuracy. The present invention addresses this need and provides additional advantages.

### SUMMARY OF THE INVENTION

In one aspect, the invention features a method for reducing speckle noise in an image of an object illuminated by a structured illumination pattern. The method includes illuminating an object with a structured illumination pattern of coherent radiation that is projected along a projection axis. The angular orientation of the projection axis is modulated over an angular range during an image acquisition interval such that shape features of the structured illumination pattern projected onto the surface of the object remain unchanged during the image acquisition interval. An image of the illuminated object is acquired during the image acquisition interval.

In another aspect, the invention features a method for reducing speckle noise in an image of an object illuminated by a structured illumination pattern. The method includes illuminating an object with a structured illumination pattern of coherent radiation projected along a projection axis at an initial angular orientation and acquiring an image of the illuminated object. The object is illuminated with the structured illumination pattern of coherent radiation projected along the projection axis at one or more subsequent angular orientations such that shape features of the structured illumination pattern projected onto the surface of the object are unchanged. Images of the illuminated object are acquired at each of the subsequent angular orientations. The images of the illuminated object at the initial angular orientation and the subsequent angular orientations of the projection axis are summed to generate an image of the illuminated object having reduced speckle noise.

In yet another aspect, the invention features a projector for reducing speckle noise in images of an illuminated object. The projector includes a source of a beam of coherent optical radiation having a structured illumination pattern. The beam propagates along a projection axis for illumination of a surface of an object. The projector also includes a dynamic beam director in optical communication with the source of the beam of coherent optical radiation. The dynamic beam director is configured to modulate an angular orientation of the projection axis such that shape features of the structured illumination pattern projected onto the surface of the object remain unchanged during modulation of the angular orientation of the projection axis.

In still another aspect, the invention features a method of reducing speckle noise in an image of an object illuminated with coherent radiation. The method includes separating a beam of coherent optical radiation into a plurality of sub-beams wherein each sub-beam has a unique optical path to an object. The optical path of at least one of the sub-beams is delayed so that each of the sub-beams has an optical path length that is different from an optical path length of each of the other sub-beams by more than a coherence length of the beam of coherent optical radiation. Each of the sub-beams is directed so that at least a portion of each sub-beam overlaps at least a portion of each of the other sub-beams at the object.

In still another aspect, the invention features an apparatus for reducing speckle noise in an image of a coherently illuminated object. The apparatus includes a coherent optical source having a coherence length, an optical delay plate and an array of lenslets. The optical delay plate is in optical communication with the coherent optical source and has a plurality of zones of unique optical thickness. Each zone has an optical thickness that is different from the optical thickness of each of the other zones by at least the coherence length of the coherent optical source. The array of lenslets is in optical communication with the optical delay plate. Each lenslet receives coherent radiation transmitted through a respective one of the zones of the optical delay plate and generates a beam of divergent coherent radiation to illuminate an object. A phase of each beam of divergent coherent radiation is advanced or delayed by the optical delay plate relative to each of the other beams of divergent coherent radiation so that the beams are not temporally coherent with respect to each other. An angle of incidence for each beam at a point on a surface of the object in a region of beam overlap is different from an angle of incidence for each of the other beams.

In still another aspect, the invention features a projector for generating a homogenized illumination pattern. The projector includes an optical source and a dynamic beam director. The optical source generates a beam of light propagating along a propagation axis. The dynamic beam director is in optical communication with the optical source and is configured to redirect the propagation axis so that the beam of light illuminates an object. The dynamic beam director modulates an angular orientation of the projection axis over an observation time wherein an illumination field is translated along the surface of the object and wherein a visibility of a non-uniformity in the illumination field is reduced over the observation time.

### BRIEF DESCRIPTION OF THE DRAWINGS

The above and further advantages of this invention may be better understood by referring to the following description in conjunction with the accompanying drawings, in which like numerals indicate like structural elements and features in the various figures. The drawings are not necessarily to scale, emphasis instead being placed upon illustrating the principles of the invention.

FIG. 1 is a block diagram of a measurement system based on accordion fringe interferometry techniques used to obtain 3D images of an object.

FIG. 2 illustrates the geometrical relationship between two virtual sources of coherent optical radiation and a projected interferometric fringe pattern at an observation plane.

FIG. 3A is a schematic figure of an embodiment of an interferometric fringe projector having reduced speckle noise according to the invention.

FIG. 3B shows an example of a fringe pattern generated by the projector of FIG. 3A.

FIG. 3C is a simplified diagram of a dynamic beam director in the form of a scan mirror at two deflection angles showing a single optical ray from a virtual source of coherent optical radiation to an object point for each deflection angle.

FIG. 4 illustrates an embodiment of an apparatus for reducing speckle noise in an image of a coherently illuminated object according to the invention.

FIG. 5 shows a front view of the optical delay plate of FIG. 4.

FIG. 6 illustrates another embodiment of an apparatus for reducing speckle noise in an image of a coherently illuminated object according to the invention.

### DETAILED DESCRIPTION

In brief overview, the present teaching relates to methods and apparatus for reducing speckle noise in images, such as images of objects illuminated by coherent light sources and images of objects illuminated by interferometric fringe patterns. According to one method, an object is illuminated with a structured illumination pattern of coherent radiation where the structured illumination pattern is projected along a projection axis. An angular orientation of the projection axis is modulated over an angular range during an image acquisition interval. Advantageously, shape features of the structured illumination pattern projected onto the surface of the object remain unchanged during image acquisition and the acquired images exhibit reduced speckle noise. The structured illumination pattern can be a fringe pattern such as an interferometric fringe pattern generated by a 3D metrology system used to determine surface information for the illuminated object.

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill in the art having access to the teaching herein will recognize additional implementations, modifications and embodiments, as well as other fields of use, which are within the scope of the present disclosure as described herein.

The methods and apparatus of the present invention have applications in systems that project structured illumination patterns onto an object. In the embodiments described below, the structured illumination patterns related primarily to interferometric fringe projection and imaging systems such as those used in determining positional information of points on the surface of an object. These 3D measurement systems can be used in dental applications for intra-oral imaging of surfaces such as the enamel surface of teeth, the dentin substructure of teeth, gum tissue and various dental structures (e.g., posts, inserts and fillings). The methods and apparatus enable high accuracy 3D measurements to be performed in real-time. It should be recognized that the methods and apparatus of the present invention are not limited to such embodiments and can be used in other systems utilizing structured illumination patterns. For example, the methods and apparatus also apply to systems using shadow mask or pattern mask projection techniques.

Phase Measurement Interferometry (“PMI”) is often used in high precision non-contact 3D metrology systems. Coherent light scattered from an object being measured is combined with coherent light from a reference source to generate an interference fringe pattern at the PMI system detector.

U.S. Pat. No. 5,870,191, incorporated herein by reference, describes a technique referred to as Accordion Fringe Interferometry (AFI) that can be used for high precision 3D measurements. AFI-based measurement systems typically employ two closely-spaced coherent optical sources to project an interferometric fringe pattern onto the surface of the object. Images of the fringe pattern are acquired for at least three spatial phases of the pattern.

PMI and AFI techniques are based on illumination of the measured object with coherent radiation. The accuracy of both techniques can be limited by the presence of speckle in the acquired images. Speckle is formed at the camera used to acquire the images as a result of the surface roughness of the object.

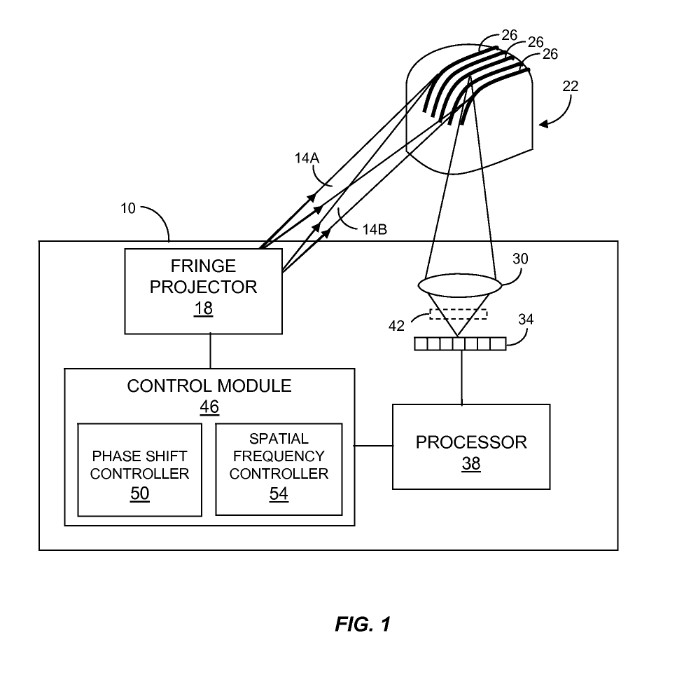

FIG. 1 illustrates an AFI-based measurement system 10 used to obtain 3D images of an object 22. Two coherent optical beams 14A and 14B generated by a fringe projector 18 are used to illuminate the surface of the object 22 with a pattern of interference fringes 26. An image of the fringe pattern at the object 22 is formed by an imaging system or lens 30 onto an imager that includes an array of photodetectors 34. For example, the detector array 34 can be a two-dimensional charge coupled device (CCD) imaging array. An output signal generated by the detector array 34 is provided to a processor 38. The output signal includes information on the intensity of the light received at each photodetector in the array 34. An optional polarizer 42 is oriented to coincide with the main polarization component of the scattered light. A control module 46 controls parameters of the two coherent optical beams 14 emitted from the fringe projector 18. The control module 46 includes a phase shift controller 50 to adjust the phase difference of the two beams 14 and a spatial frequency controller 54 to adjust the pitch, or separation, of the interference fringes 26 at the object 22.

The spatial frequency of the fringe pattern is determined by the separation of two virtual sources of coherent optical radiation in the fringe generator 18, the distance from the virtual sources to the object 22, and the wavelength of the radiation. As used herein, a virtual source means a point from which optical radiation appears to originate although the actual source of the optical radiation may be located elsewhere. The processor 38 and control module 46 communicate to coordinate the processing of signals from the photodetector array 34 with respect to changes in phase difference and spatial frequency, and the processor 38 determines three-dimensional information for the object surface according to the fringe pattern images.

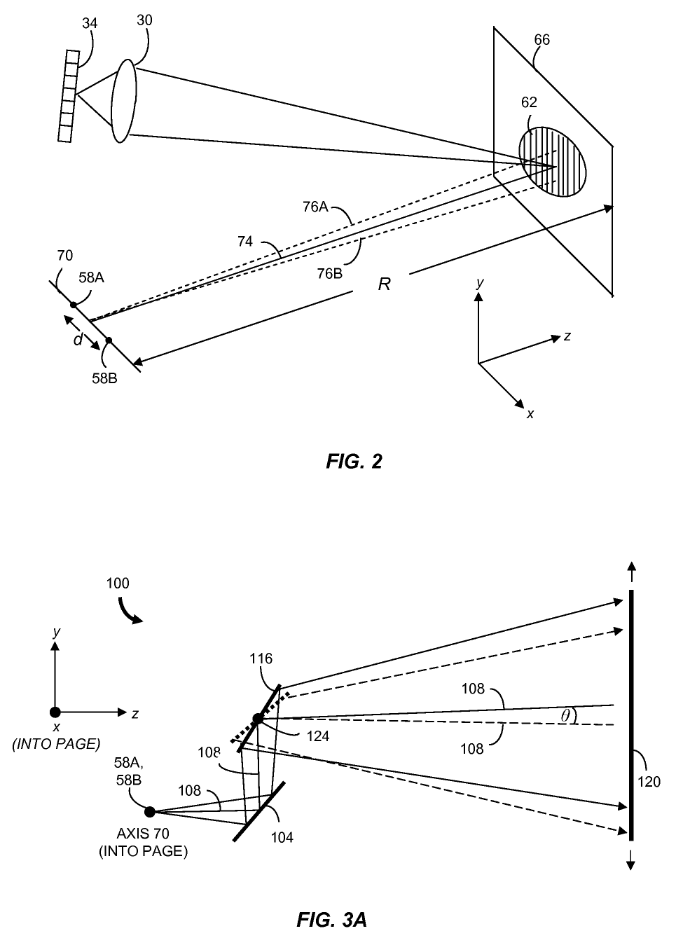

FIG. 2 illustrates the geometrical relationship between the virtual sources 58A and 58B of coherent optical radiation and the projected interferometric fringe pattern 62 at an observation plane 66. The virtual sources 58 lie along a first horizontal axis 70 (i.e., the x axis) separated from the observation plane 66 by a distance R. A pair of divergent optical beams propagating from the virtual sources 58 interfere in their region of overlap to generate the fringe pattern 62. The fringes are substantially linear across the overlap region if the distance R to the observation plane 66 is significantly greater than the separation d between the virtual sources 58. The fringe pattern 62 is projected along a second horizontal axis 74 (i.e., the z axis) that is orthogonal to the first horizontal axis 70. One of skill in the art will recognize that the y-z plane bisects the fringe pattern 62 and is equidistant from the two virtual sources 58. Thus the second horizontal axis 74, or projection axis, intersects the observation plane 66 at the center of the fringe pattern 62.

Images of the fringe pattern 62 illuminating an object typically exhibit speckle. The characteristics of the speckle are determined according to the surface roughness of the object, the wavelength of the coherent optical radiation and the configuration of the imaging system. Optical imagers with increased spatial resolution typically acquire images with more speckle noise as the intensity variations, or speckle features, at a single imaging element are not averaged as effectively as with lower resolution optical imagers where more speckle features are present on an imaging element.

According to one embodiment of a method for reducing speckle noise in an image of an interferometric fringe pattern projected onto an object, the direction of propagation of the divergent optical beams is rotated, or pivoted, about a point midway between the virtual sources 58 such that the fringe pattern 62 moves vertically along a surface of an illuminated object. In effect, the orientation of the projection axis 74 is swept in angle between the upper dashed line 76A and lower dashed line 76B in the y-z plane as shown in the figure, causing the illuminated region to be translated vertically (i.e., parallel to the y-axis) along the surface of the object. If the distance from the virtual sources 58 to the object is large relative to the separation d of the virtual sources 58, the phase difference defined between the optical radiation from the two virtual sources incident at a point on the object does not change during the angular modulation. Thus the fringes do not change shape as the position of the fringe pattern 62 is swept vertically. The magnitude of the cyclic angular motion is selected to cause changes in the vertical position of the fringe pattern 62 that maintain illumination of the object or area of interest on the object while achieving averaging of the speckle pattern in the fringe images. Averaging occurs by translating the speckle across multiple imaging elements during an image acquisition interval. Thus the speckle noise in the acquired images is substantially reduced. In an alternative embodiment, multiple images are acquired at discrete angular positions (i.e., angular steps) throughout the angular range. The images are summed to average, or “wash out”, the speckle present in the individual images.

It should be noted that the invention contemplates various configurations in which the projection axis 74 extending from the virtual sources 58 is redirected, for example, by reflective optical components such as fold mirrors, with no adverse effect on the ability to sweep the fringe pattern 62 over a limited angular range while maintaining the shape of the fringes. For example, the projection axis 74 can be folded a number of times as long as the angular sweep maintains the direction of propagation of the projected fringe pattern in a plane that is effectively orthogonal to the axis 70 of the virtual sources 58 when accounting for rotation of an optical reference coordinate system by fold mirrors and other optical components. Such changes in the reference coordinate system do not alter the equidistant relationship between any point on the projection axis 74 and the virtual sources 58.

The angular deflection θₛ required to translate speckle from one detector pixel to an adjacent detector pixel is a function of the detector aperture and geometry. Speckle is reduced by a factor of N where

$$N = \sqrt{\frac{{θ}_{m}}{{θ}_{s}}}$$

and θₘ equals the angle of optical axis deflection achieved by the dynamic beam director that imparts the angular motion. For example, in an optical system where θₛ is approximately 1.0°, an optical rotation θₘ of ±4.5° of the beam director results in a reduction of speckle noise by a factor N of approximately three.

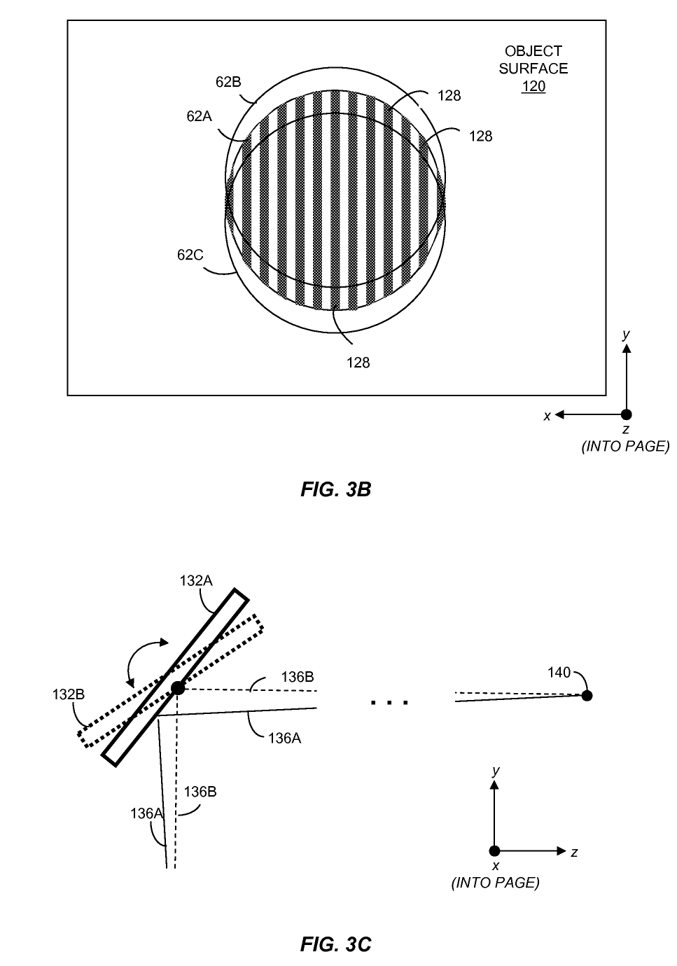

FIG. 3A illustrates an embodiment of an interferometric fringe projector 100 having reduced speckle noise according to the invention. The fringe projector 100 includes virtual sources 58A and 58B disposed on an axis 70. Each virtual source 58 is at the apex of a divergent optical beam. A mirror 104 folds the propagation path 108 of the pair of beams. A dynamic beam director 116 redirects the propagation path 108 so that the divergent optical beams illuminate an object surface 120. The object surface 20 shown in the figure is a planar surface although it should be recognized that a surface can have any shape. The dynamic beam director 116 rotates back and forth about an axis 124 (into page) through an angle θ/2. FIG. 3B shows the fringe pattern at a position 62A on the planar surface 120 when the dynamic beam director 116 is at an angular position that is midway in the angular range. Also shown are the outlines 62B and 62C of the fringe pattern at a maximum angular position (θ/2) and a minimum angular position (−θ/2), respectively.

By way of a numerical example, the distance R from the virtual sources 58 to an object is 115 mm with 40 fringes at a fringe pitch of 400 μm present across the field of view of a camera used to acquire the fringe images. The dynamic beam director 116 rotates through an angular range θ of 5° during an image acquisition interval (e.g., camera integration time) for a single image of the fringe pattern so that the propagation path is swept through a full angular range of 10°. The wobble in the axis of rotation 124 during an angular sweep is maintained at a small value (e.g., less than one milliradian) to avoid imparting a significant phase shift to the fringe pattern. In this example, there is substantially no distortion to the fringe structure due to the angular modulation and therefore measurement accuracy is maintained.

In a specific embodiment, the dynamic beam director is a fixed frequency resonant optical scanner providing continuous sinusoidal angular motion such as scanner model no. SC-3 available from Electro-Optical Products Corporation of Ridgewood, N.Y. The angular modulation is performed at a rate (e.g., 600 Hz) sufficient for the fringe pattern to be swept through the full angular range at least one time during each image acquisition interval while maintaining the second axis 108 orthogonal to the first axis 70. To enable image calibration and uniformity, angular modulation is preferably synchronized with the acquisition of fringe images, for example, by using an angular position sensor to coordinate the angular position of the dynamic beam director 116 with the timing of the image acquisition system.

The fringe pattern projected in space has substantially straight vertical fringes even at the pattern edge (as shown, for example, by the fringes 128 on the planar surface 120 in FIG. 3B) if the separation d of the virtual sources 58 is substantially less than the distance R to the fringe pattern. One of skill in the art will recognize that the shape of the fringes on an illuminated object will vary according to the surface geometry of the object and that nonplanar surfaces will exhibit fringes having structures that are generally not linear. Regardless of object shape, it will be appreciated that the shapes of the fringes observed on the object remain unchanged across the full range of the angular sweep. Thus the 3D information that can be derived from the fringe pattern is not lost or degraded by the angular modulation. Moreover, phase errors in the initial fringe pattern due to optical distortions in the fringe projection optics are averaged out and the illumination is effectively homogenized in one dimension.

FIG. 3C illustrates the dynamic beam director, implemented as a scan mirror 132 (e.g., galvanometer mirror), for positions 132A and 132B corresponding to two different deflection angles. A single optical ray 136A or 136B from one of the virtual sources 58 is incident on an object point 140 for each deflection angle, showing how the optical path length from the virtual sources 58 varies as the deflection angle is changed.

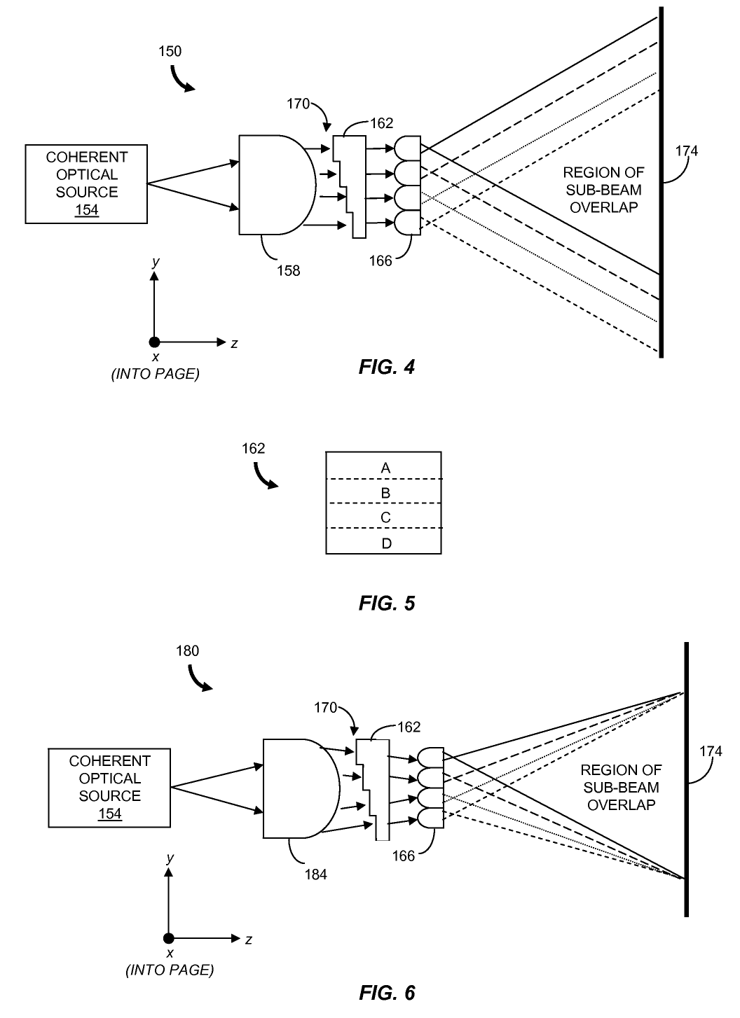

The embodiments described above utilize angular diversity to reduce the speckle noise in images of coherently illuminated objects. Referring to FIG. 4, another embodiment of an apparatus 150 for reducing speckle noise in an image of a coherently illuminated object is based on angular diversity in the illumination field. The apparatus 150 includes a source of coherent optical radiation 154, a cylindrical collimating lens 158, an optical delay plate 162 and a linear array 166 of cylindrical lenslets. A plurality of sub-beams, one for each lenslet in the array 166, is generated with each sub-beam having an illumination subfield. The illumination subfields overlap such that each point in the region receives light incident at different angles. As a result, the total speckle noise in an image of the illuminated object is reduced by the averaging of the speckle noise for all of the illumination subfields. The apparatus 150 has the benefit of no moving components; however, the tolerances imposed on the transmissive optical components must be specified to prevent the introduction of significant optical aberrations.

In operation, the cylindrical collimating lens 158 receives coherent optical radiation from the optical source 154 and provides a beam 170 that is collimated in one dimension to the optical delay plate 162 and lenslet array 166. After passing through a nominal focus position, coherent radiation from each lenslet expands as a divergent sub-beam displaced from the other divergent sub-beams propagating from the lenslet array 166. Each point on the object surface 174 in the region of overlap common to all four divergent sub-beams receives a contribution from each divergent sub-beam.

Referring to FIG. 5, a front view of the optical delay plate 162 shows four zones, or steps, A, B, C and D each having a unique optical thickness that differs from the optical thicknesses of the other zones by more than the coherence length of the coherent optical source 154. The optical thickness is determined by the physical thickness of the optical substrate or glass; however, in other embodiments, the optical thickness for each zone is based on different indices of refraction for each zone, or a combination of an index of refraction and a physical thickness for each zone such that each zone has a different optical thickness. Thus the light exiting each zone at the back side of the optical delay plate 162 is no longer temporally coherent with respect to the light exiting the other zones. For the illustrated four zone optical delay plate 162, the magnitude of the speckle in the acquired images is reduces by two compared to a conventional coherent illumination of the object. Advantageously, unwanted fringes that may otherwise be present in images of the illuminated object due to interference between pairs of divergent sub-beams are avoided. By way of a numerical example, an optical delay plate 162 for a system employing a coherent optical source 154 having a coherence length of 1 mm will have steps of unique optical thickness that differ from the optical thicknesses of the other steps by at least 1 mm.

The coherent optical source 154 of FIG. 4 can include a pair of virtual sources to generate a fringe pattern at the object as described above with respect to FIGS. 1 to 3. In such instances, each illumination subfield generated by the apparatus 150 includes a fringe pattern that is offset vertically from the fringe patterns of the other subfields. Advantageously, the speckle observable in a fringe pattern for a single illumination subfield is averaged with the speckle of the fringe patterns in the other illumination subfields so that the total speckle noise in a single image of all illumination subfields has reduced speckle noise.

FIG. 6 illustrates another embodiment of an apparatus 180 for reducing speckle noise in an image of a coherently illuminated object. The apparatus 180 is configured similar to the apparatus 150 of FIG. 4 and multiple illumination subfields are created at with different angles of incidence at each point on the object surface; however, the cylindrical collimating lens 158 is replaced with a focusing optical element 184 that, in combination with the linear lenslet array 166, is positioned so that the four illumination subfields fully overlap at the object. For a generalized object that does not have a planar surface, the focusing optical element 184 and lenslet array 166 are configured to provide fully overlapping illumination subfields at an object midplane. Thus the apparatus 180 is more optically efficient than the configuration shown in FIG. 4.

Although the embodiments described above relate to coherent illumination, the invention contemplates the use of angular diversity for reducing the effect of non-uniformities in coherent and incoherent illumination beams. Non-uniformities are generated for a variety of reasons, including defects in optical components and dust in the optical path. The angular modulation described above with respect to FIG. 2 and FIG. 3 can be used to generate a homogenized illumination beam. Angular modulation causes the illumination region at an object to translate in one or two dimensions. With sufficient angular magnitudes and modulation rates, any spatial non-uniformities or intensity features in the illumination are less obvious to an observer and effects of the non-uniformities are reduced in images of the illuminated object.

While the invention has been shown and described with reference to specific embodiments, it should be understood by those skilled in the art that various changes in form and detail may be made therein without departing from the spirit and scope of the invention.

What is claimed is:

1. A method for reducing speckle noise in an image of an object illuminated by a structured illumination pattern, the method comprising:
illuminating an object with a structured illumination pattern of coherent radiation, the structured illumination pattern being projected along a projection axis;
modulating an angular orientation of the projection axis over an angular range during an image acquisition interval, wherein shape features of the structured illumination pattern projected onto the surface of the object remain unchanged during the image acquisition interval; and
acquiring an image of the illuminated object during the image acquisition interval.

2. The method of claim 1 wherein the modulation occurs at a frequency that is synchronized to an image acquisition rate.

3. The method of claim 1 wherein the structured illumination pattern is a fringe pattern and wherein a shape of the fringes does not change during the modulation of the angular orientation of the projection axis.

4. The method of claim 3 wherein the fringe pattern is generated by an interference of two sources of coherent optical radiation.

5. The method of claim 1 wherein the structured illumination pattern is generated by illuminating a pattern mask with coherent optical radiation.

6. A method for reducing speckle noise in an image of an object illuminated by a structured illumination pattern, the method comprising:
illuminating an object with a structured illumination pattern of coherent radiation projected along a projection axis at an initial angular orientation;
acquiring an image of the illuminated object;
illuminating the object with the structured illumination pattern of coherent radiation projected along the projection axis at one or more subsequent angular orientations, wherein shape features of the structured illumination pattern projected onto the surface of the object are unchanged;
acquiring an image of the illuminated object at each of the subsequent angular orientations; and
summing the images of the illuminated object at the initial angular orientation and the subsequent angular orientations of the projection axis to generate an image of the illuminated object having reduced speckle noise.

7. The method of claim 6 wherein the structured illumination pattern is a fringe pattern and wherein a shape of the fringes is the same in each of the images.

8. The method of claim 7 wherein the fringe pattern is generated by an interference of two sources of coherent optical radiation.

9. The method of claim 6 wherein the structured illumination pattern is generated by illuminating a pattern mask with coherent optical radiation.

10. A projector for reducing speckle noise in images of an illuminated object, comprising:
a source of a beam of coherent optical radiation having a structured illumination pattern, the beam propagating along a projection axis and configured for illumination of a surface of an object; and
a dynamic beam director in optical communication with the source of the beam of coherent optical radiation and configured to modulate an angular orientation of the projection axis, wherein shape features of the structured illumination pattern projected onto the surface of the object remain unchanged during modulation of the angular orientation of the projection axis.

11. The projector of claim 10 wherein the source of the beam of coherent radiation comprises a pair of sources of coherent optical radiation and wherein the structured illumination pattern is an interferometric fringe pattern.

12. The projector of claim 11 wherein the pair of sources of coherent optical radiation is a pair of virtual sources of coherent optical radiation.

13. The projector of claim 10 wherein the dynamic beam director is a scan mirror.

14. The projector of claim 13 wherein the scan mirror is a galvanometer mirror.

15. The projector of claim 10 further comprising an imaging system to acquire images of the object illuminated by the structured illumination pattern.

16. The projector of claim 10 wherein the dynamic beam director is configured to modulate the angular orientation of the projection axis over a continuous angular range.

17. The projector of clam 10 wherein the dynamic beam director is configured to modulate the angular orientation of the projection axis in discrete angular steps.

18. A method of reducing speckle noise in an image of an object illuminated with coherent radiation, the method comprising:
separating a beam of coherent optical radiation into a plurality of sub-beams wherein each sub-beam has a unique optical path to an object;
delaying the optical path of at least one of the sub-beams so that each of the sub-beams has an optical path length that is different from an optical path length of each of the other sub-beams by more than a coherence length of the beam of coherent optical radiation; and
directing each of the sub-beams so that at least a portion of each sub-beam overlaps at least a portion of each of the other sub-beams at the object.

19. The method of claim 18 further comprising acquiring an image of the object.

20. The method of claim 18 wherein the beam of coherent radiation comprises a pair of coherent optical beams and wherein a fringe pattern is projected onto the object.

21. The method of claim 20 further comprising acquiring an image of the fringe pattern projected onto the object.

22. An apparatus for reducing speckle noise in an image of a coherently illuminated object, comprising:
a coherent optical source having a coherence length;
an optical delay plate in optical communication with the coherent optical source and having a plurality of zones of unique optical thickness, the optical thickness of each zone being different from the optical thickness of each of the other zones by at least the coherence length of the coherent optical source; and
an array of lenslets in optical communication with the optical delay plate, each of the lenslets receiving coherent radiation transmitted through a respective one of the zones of the optical delay plate and generating a beam of divergent coherent radiation to illuminate an object, wherein a phase of each beam of divergent coherent radiation is advanced or delayed by the optical delay plate relative to each of the other beams of divergent coherent radiation so that the beams are not temporally coherent with respect to each other and wherein an angle of incidence for each beam at a point on a surface of the object in a region of beam overlap is different from an angle of incidence for each of the other beams.

23. The apparatus of claim 22 wherein the lenslets are cylindrical lenslets.

24. The apparatus of claim 22 further comprising a focusing optical element disposed between the coherent optical source and the optical delay plate.

25. The apparatus of claim 24 wherein the focusing optical element is a cylindrical lens.

26. The apparatus of claim 24 wherein the focusing optical element is a collimator and wherein the collimator receives a divergent beam of coherent radiation from the coherent optical source and provides a collimated beam to the optical delay plate.

27. The apparatus of claim 24 wherein the focusing element and the array of lenslets are configured so that the illumination of each beam of divergent coherent radiation at the object completely overlaps the illumination of each of the other beams of divergent coherent radiation at the object.

28. The apparatus of claim 24 wherein the focusing element is a cylindrical lens.

29. The apparatus of claim 22 wherein a thickness of the optical delay plate at each of the zones is different than a thickness of the optical delay plate at each of the other zones.

30. A projector for generating a homogenized illumination pattern, comprising:
an optical source generating a beam of light propagating along a propagation axis; and
a dynamic beam director in optical communication with the optical source and configured to redirect the propagation axis so that the beam of light illuminates an object, the dynamic beam director modulating an angular orientation of the projection axis over an observation time wherein an illumination field is translated along the surface of the object and wherein a visibility of a non-uniformity in the illumination field is reduced over the observation time.

31. The projector of claim 30 wherein the optical observation time is an image acquisition time for an imaging system.
